(19) United States
(12) Patent Application Publication
(10) Pub. No.: US 2016/0286827 A1
(43) Pub. Date: Oct. 6, 2016

(54) Skinning and Cleaning Knife

(71) Applicant: Willard Smith, Blountstown, FL (US)

(72) Inventor: Willard Smith, Blountstown, FL (US)

(21) Appl. No.: 14/676,126

(22) Filed: Apr. 1, 2015

(51) Int. Cl. A22B 5/16; B26B 9/00

(52) U.S. Cl. CPC A22B 5/168; B26B 9/00

(57) ABSTRACT

A skinning or cleaning knife, including a primary knife edge having in its preferred embodiment an elongate primary edge with a convex curved edge at its distal tip adjacent the point of the blade, a secondary edge at the distal tip of the back edge of the blade having a concave curve, and a convex protrusion for gripping purposes located intermediate said secondary edge and a neck of the knife adjacent the handle of the knife, which neck is also preferably concavely curved. In the preferred embodiments, the protrusion also features an aperture or hole which assists in gripping the protrusion and also furthers the impression of a “duck head” shape and likeness for sales purposes.

### CROSS-REFERENCE TO RELATED APPLICATIONS

This application claims an invention that was disclosed in U.S. Provisional Application No. 61/981,541, filed 18 Apr. 2014, entitled “Skinning and Cleaning Knife”. The benefit under 35 USC §119(e) and/or other applicable law of the aforesaid United States provisional application is hereby claimed, and the aforementioned application is hereby incorporated herein by reference.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

The present invention relates to hunting knives and particularly skinning and cleaning knives for small game including water fowl. More specifically, the invention pertains to a unique skinning and cleaning knife with a protrusion on its back that allows gripping the knife for “fine” cutting work using the tip of the knife by grasping the knife between the user's thumb and index finger. Gripping of the protrusion is further assisted by the presence of a “duck's eye” hole in the protrusion. From the standpoint of sales, it should be noted that the overall shape of the blade of the knife resembles the head of a duck in flight, greatly adding to customer appeal. This resemblance is enhanced by the “duck's eye” hole in the protrusion, increasing the resemblance of the knife blade to a duck'. The field of the invention includes hunting knives generally, and is replete with hunting knives having different shapes and designs, some of which are shaped for general purpose outdoor usage (generally by rugged and robust construction and features), and others being more specifically adapted for skinning and cleaning game by, for example, specific shapes or skin ripping features. However, none features the distinctive shape and features of the instant skinning and cleaning knife.

### SUMMARY OF THE INVENTION

The cleaning and skinning knife described herein features a handle, and blade with a primary cutting edge with a tip that is convexly curved and a secondary cutting edge located at the tip of the back side of the blade having a concavely curved edge. The primary cutting edge and tip is suitable for normal draw cutting. Conversely, the concave curve of the secondary edge is highly suited for hooking under and pushing forward and/or drawing upward. A protrusion is formed approximately mid-way along the back of the knife blade. This protrusion allows the back of the blade to be safely and firmly gripped in a pinch grip between the thumb and index finger of a user, allowing a strong and stable grip for using the two edges of the knife tip for “fine” or “close” work in the cleaning and skinning process. The presence of an optional “duck's eye” hole as shown further assists in gripping and utilizing the knife. The features described also create the profile image of a duck head as stretched out in flight, serving to increase its attractiveness to intended consumers.

### BRIEF DESCRIPTION OF THE DRAWINGS

The novel features believed to be characteristic of this invention are set forth with particularity in the appended claims. The invention itself, however, both as to its organization and method of operation, together with further object and advantages thereof, may be better understood by reference to the following description taken in connection with the accompanying drawings in which:

FIG. 1 provides a schematic side elevation illustrating in general fashion the features of my invention.

FIG. 2 provides a schematic perspective illustration of the manner in which the protrusion on the back of the knife of my invention allows one to grip the knife for “fine” cutting work using the tip of the knife by grasping the knife between thumb and index finger.

### DESCRIPTION

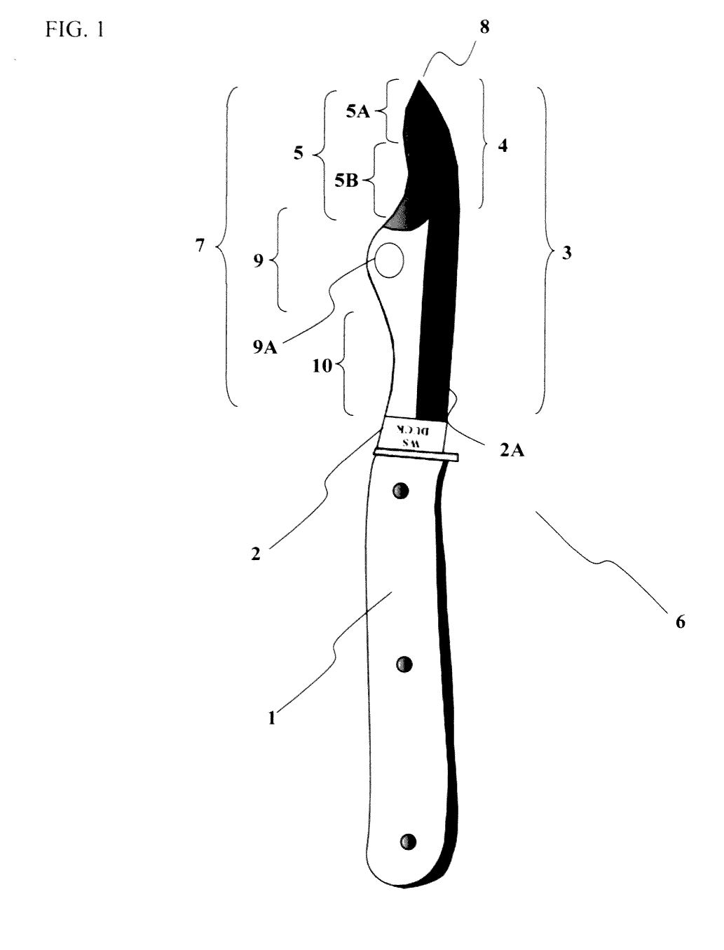

Turning first to FIG. 1, it will be seen that the cleaning and skinning knife 6 of my invention features a handle 1 and blade 2 as is normal in prior art. At this point it should also be remarked that, though a fixed blade knife 6 is shown in the drawing figures, the invention also comprehends folding or pocket knives, the technology described herein being easily practiced and embodied in either fixed or folding knives by those of ordinary skill in the art.

The blade 2 has a primary cutting edge 3 on what would normally be the underhand side of the knife 6 with the tip 4 of said primary cutting edge 3 being convexly curved in the preferred embodiment shown such that edge 3 crosses an initial portion of centerline 2A adjacent handle 1 of the blade 2. A secondary cutting edge 5 is located at the tip of the back side 7 of the blade 2. The secondary cutting edge 5 features a generally concavely curved edge featuring a somewhat more convex portion 5A adjacent point 8 blending into a more concave portion 5B such that edge 5 rounds to the point 8 of the blade 2, where the primary edge 3 and the secondary edge 6 meet. These shapes create a standard convex curve in the blade at the primary tip 4 suitable for normal draw cutting. Conversely, the curves 5A, 5B of the secondary edge 5 create a blade surface including hook-like features that is highly suited for ripping, hooking under and pushing forward, and/or drawing upward where necessary and/or advisable for skinning and cleaning purposes. The combined visual affect of the two blade edge shapes 4, 5 is to create the distinctive hook shape at the tip of blade 2 of knife 6 with, in the preferred embodiments, a slightly upswept tip 8 (which also assists in creating a “duck bill” appearance which is valuable in terms of the appearance goals discussed in more detail below).

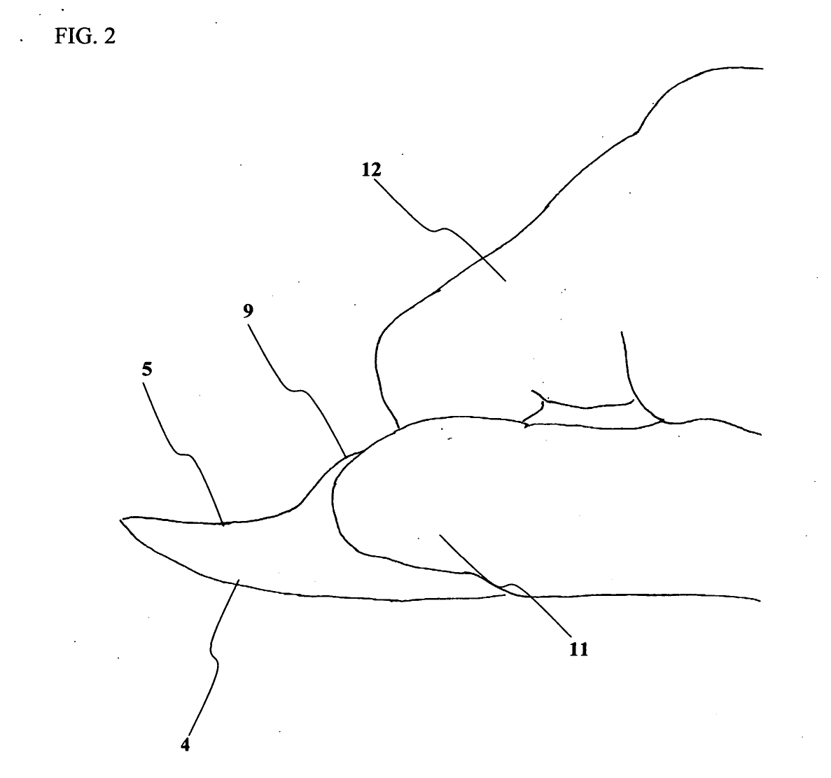

As will be noted, the most prominent feature of the back 7 of the knife 6 shown is the protrusion 9 formed approximately mid-way along the back 7 of the knife blade 2. This protrusion 9 in combination with the concave shape of blade back neck 10 creates an ideal hand-fitting curve that allows the back 7 of the blade to be safely and firmly gripped in the trimmer illustrated in FIG. 2 with protrusion 9 held in a pinch grip between the thumb 10 and the side or tip of the index finger 11. The presence of “duck's eye” hole 9A, which is typically approximately ¼ inch in diameter, assists in this process as it allows the finger 11 and thumb 10 to make skin to skin contact, creating better grip/traction and allowing better push/pull action via contact with the edges of the eye hole 9A. These features create a strong and stable grip that allows the secondary edge 5 as well as the primary tip 4 and the primary edge 3 to be used with the deftness and assurance of the surgeon's scalpel when necessary or advisable for “fine” or “close” work in the cleaning and skinning process.

A further benefit of the above-referenced features and another benefit of the design of the invention is the creation, by combination of the aforesaid functional shapes, of the profile image of a duck head as stretched out in flight. This serves to further the goal of creating a highly efficient cleaning and skinning knife that not only performs its primary functions with the added advantages previously described, but also is attractive in appearance and attractive to the intended consumer and purchaser, who will typically be a hunter, and will be drawn by the described appearance of the duck's head embodied in the knife's outline and “eye”.

### PARTS AND FEATURES ILLUSTRATED IN DRAWING FIGURES

1 Knife handle
2 Knife blade
2A Initial portion of blade centerline
3 Primary edge
4 Primary tip
5 Secondary edge
5A convex portion of secondary edge
5B concave portion of secondary edge
6 Knife, including handle and blade
7 Back of blade
8 Point of blade
9 Protrusion
9A “Duck's Eye” hole in protrusion 9
10 Neck of blade back
11 Thumb of user
12 Index finger of user

In view of the foregoing, it should be clear that numerous changes and variations can be made without exceeding the scope of the inventive concept outlined. Accordingly, it is to be understood that the embodiment(s) of the invention herein described is/are merely illustrative of the application of the principles of the invention. Reference herein to details of the illustrated embodiment(s) is not intended to limit the scope of the claims, which recite those features regarded as essential to the invention.

1. A skinning or cleaning knife, comprising:
a handle with a pointed knife blade protruding therefrom, said knife blade and handle having an upper side and an underside;
wherein the underside of said knife blade has an elongate primary edge;
wherein the upper side of said knife blade has a secondary edge at its distal tip adjacent the point of the blade; and
wherein the upper side of said knife blade has a convex protrusion for gripping purposes located intermediate said secondary edge and a neck of the knife adjacent the handle of the knife.

2. The knife of claim 1, wherein the primary edge has a convex curved portion at its distal tip adjacent the point of the blade.

3. The knife of claim 2, wherein said convex curved portion crosses an initial portion of the blade centerline.

4. The knife of claim 1, wherein said secondary edge is at least one of: substantially concave, and substantially concave with a more convex portion adjacent the point blending into a more concave portion such that the secondary edge rounds to the point of the blade.

5. The knife of claim 2, wherein said secondary edge is at least one of: substantially concave, and substantially concave with a more convex portion adjacent the point blending into a more concave portion such that the secondary edge rounds to the point of the blade.

6. The knife of claim 3, wherein said secondary edge is at least one of: substantially concave, and substantially concave with a more convex portion adjacent the point blending into a more concave portion such that the secondary edge rounds to the point of the blade.

7. The knife of claim 1, wherein a gripping hole is provided in said protrusion to assist in gripping the knife by said protrusion.

8. The knife of claim 2, wherein a gripping hole is provided in said protrusion to assist in gripping the knife by said protrusion.

9. The knife of claim 3, wherein a gripping hole is provided in said protrusion to assist in gripping the knife by said protrusion.

10. The knife of claim 4, wherein a gripping hole is provided in said protrusion to assist in gripping the knife by said protrusion.

11. The knife of claim 5, wherein a gripping hole is provided in said protrusion to assist in gripping the knife by said protrusion.

12. The knife of claim 6, wherein a gripping hole is provided in said protrusion to assist in gripping the knife by said protrusion.

13. The knife of claim 1, wherein at least one of: the aforesaid features of the knife blade create the profile of an extended duck or waterfowl profile, said aid neck is concave.

14. The knife of claim 2, wherein at least one of: the aforesaid features of the knife blade create the profile of an extended duck or waterfowl profile, said aid neck is concave.

15. The knife of claim 3, wherein at least one of: the aforesaid features of the knife blade create the profile of an extended duck or waterfowl profile, said aid neck is concave.

16. The knife of claim 4, wherein at least one of the aforesaid features of the knife blade create the profile of an extended duck or waterfowl profile, said aid neck is concave.

17. The knife of claim 5, wherein at least one of: the aforesaid features of the knife blade create the profile of an extended duck or waterfowl profile, said aid neck is concave.

18. The knife of claim 6, wherein at least one of: the aforesaid features of the knife blade create the profile of an extended duck or waterfowl profile, said aid neck is concave.

19. The knife of claim 7, wherein at least one of: the aforesaid features of the knife blade create the profile of an extended duck or waterfowl profile, said aid neck is concave.

20. The knife of claim 8, wherein at least one of the aforesaid features of the knife blade create the profile of an extended duck or waterfowl profile, said aid neck is concave.
